(19) United States
(12) Patent Application Publication
(10) Pub. No.: US 2024/0386600 A1
(43) Pub. Date: Nov. 21, 2024

(54) PHYSIQUE DETERMINATION DEVICE AND PHYSIQUE DETERMINATION METHOD

(71) Applicant: Mitsubishi Electric Corporation, Tokyo (JP)

(72) Inventors: Yayoi HAYASHI, Tokyo (JP); Naoya BABA, Tokyo (JP); Hirotaka SAKAMOTO, Tokyo (JP)

(73) Assignee: Mitsubishi Electric Corporation, Tokyo (JP)

(21) Appl. No.: 18/693,157

(22) PCT Filed: Nov. 12, 2021
(86) PCT No.: PCT/JP2021/041747

§ 371 Date: Mar. 19, 2024

(51) Int. Cl. G06T 7/73; G06F 21/32; G06V 20/59

(52) U.S. Cl. CPC G06T 7/73; G06F 21/32; G06V 20/59

(57) ABSTRACT

A physique determination device (1) includes: a postural information acquiring unit (11) to acquire information about a posture of an occupant; a feature identifying unit (12) to identify a feature for which the calculation condition is satisfied on the basis of the information about the posture of the occupant from among a plurality of features that is to be used for determination of a physique of the occupant, the plurality of features each including a set calculation condition for calculating a value of the feature; a feature calculating unit (13) to calculate, on the basis of a captured image, the value of the feature identified by the feature identifying unit; and a physique determining unit (14) to determine the physique of the occupant on the basis of the value of the feature calculated by the feature calculating unit.

### TECHNICAL FIELD

The present disclosure relates to a human physique determination device and a human physique determination method.

### BACKGROUND ART

There are conventionally known technologies to determine physiques by using features of the bodies calculated on the basis of captured images. Improvement of the precision of physique determination requires precise calculation of the values of the features of the bodies. For example, Patent Literature 1 discloses a technology to calculate the values of features of a body on the basis of a captured image captured in a case where vehicle information satisfies particular conditions.

### CITATION LIST

### Patent Literatures

Patent Literature 1: JP 2019-55759 A

### SUMMARY OF INVENTION

### Technical Problem

However, the conventional technology described in Patent Literature 1 has disadvantages that since the values of features of a body are calculated on the basis of captured images captured under the same conditions irrespective of the types of the features, the precision of calculation of the values of the features is low, and the precision of physique determination is low.

The present disclosure has been made to solve the disadvantages described above, and an object thereof is to improve the precision of calculation of the values of features, and to improve the precision of physique determination.

### Solution to Problem

A physique determination device according to the present disclosure includes: a postural information acquiring unit to acquire information about a posture of an occupant; a feature identifying unit to identify a feature for which a calculation condition is satisfied on the basis of the information about the posture of the occupant from among a plurality of features that is to be used for determination of a physique of the occupant, the plurality of features each including a set calculation condition for calculating a value of the feature; a feature calculating unit to calculate, on the basis of a captured image, the value of the feature identified by the feature identifying unit; and a physique determining unit to determine the physique of the occupant on the basis of the value of the feature calculated by the feature calculating unit.

### Advantageous Effects of Invention

Since the precision of calculation of the values of a plurality of features is improved by calculating the value of each of the features on the basis of a captured image suited for the calculation of the value of the feature according to the present disclosure, the precision of physique determination can be improved.

### BRIEF DESCRIPTION OF DRAWINGS

FIG. 1 is a figure depicting a configuration example of a physique determination device according to a first embodiment.

FIG. 2 is a figure depicting an example of a calculation condition set for each type of feature in the first embodiment.

FIGS. 3A and 3B are figures depicting examples of captured images in a case where the left-right orientation of a body is the forward-facing orientation, and in a case where the left-right orientation of the body is the rightward-facing orientation in the first embodiment.

FIGS. 4A and 4B are figures depicting examples of captured images in a case where the up-down orientation of a face is the horizontally-facing orientation, and in a case where the up-down orientation of the face is the upward-facing orientation relative to the horizontally-facing orientation, in the first embodiment.

FIGS. 5A and 5B are figures depicting examples of captured images in a case where the left upper arm is not extended forward, and in a case where the left upper arm is extended forward, in the first embodiment.

FIG. 6 is a flowchart for explaining an operation of the physique determination device according to the first embodiment.

FIGS. 7A and 7B are figures depicting hardware configuration examples of the physique determination device according to the first embodiment.

### DESCRIPTION OF EMBODIMENTS

Hereinbelow, an embodiment of the present disclosure is explained in detail with reference to the figures.

### First Embodiment

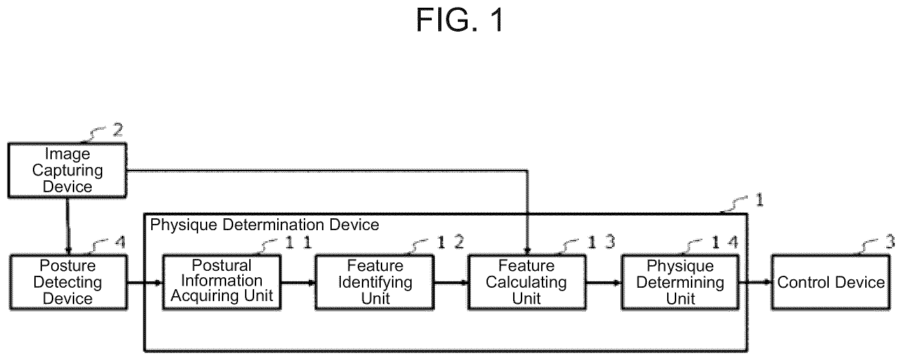

A physique determination device 1 in a first embodiment is explained by using FIG. 1 to FIGS. 7A and 7B.

It is assumed here that the physique determination device 1 is mounted on a vehicle in the present first embodiment.

FIG. 1 is a figure depicting a configuration example of the physique determination device 1.

The physique determination device 1 determines a physique on the basis of a plurality of features of the body, and outputs information about the physique as a result of the determination. Features are, for example, the “length of the shoulder width,” the “length of the neck,” the “length of an upper arm” or the like, and the plurality of features to be used for the determination of the physique are predetermined. Details of the features are mentioned later.

It is assumed in the present first embodiment that the physique determination device 1 determines the physique as any of “infant,” “small build,” “normal.” and “large build.” Then, for example, the information about the physique may be a numerical value representing a physique like “0: infant,” “1: small build,” “2: normal” or “3: large build” or may be an index number representing the level of a physique size.

The physique determination device 1 is connected with an image capturing device 2, a control device 3 and a posture detecting device 4.

The image capturing device 2 captures an image of an occupant in the interior of the vehicle, and outputs the captured image. For example, the image capturing device 2 is a near-infrared ray camera or a visible light camera. The image capturing device 2 is installed at such a position that the image capturing device 2 can capture at least an image of an area where the upper half of the body of an occupant in the interior of the vehicle is assumed to be present. For example, the area where the upper half of the body is assumed to be present is an area equivalent to the space in front of the backrest and headrest of a seat.

In the present first embodiment, as an example, the image capturing device 2 is installed at the middle of the instrument panel (hereinbelow, described as the “instrument panel”) of the vehicle, and captures an image of the front seats including the driver's seat and the passenger seat from the middle of the instrument panel. Note that the installation position of the image capturing device 2 is not limited to the middle of the instrument panel, but may be in front of each seat, for example.

The control device 3 controls vehicle-mounted equipment on the basis of determination results output by the physique determination device 1. For example, the vehicle-mounted equipment is an airbag control device, a seat belt control device, a notification control device and the like. Note that vehicle-mounted equipment controlled by the control device 3 is not limited to these.

The airbag control device is an engine control unit (ECU) for an airbag system, and controls the inflation of airbags on the basis of determination results output by the physique determination device 1 for suppressing injuries at the time of the inflation of the airbags. Specifically, the airbag control device performs control in such a manner that an airbag does not inflate in a case where the physique is “infant,” an airbag inflates at lower speed in a case where the physique is “small build,” and so on.

The seat belt control device adjusts the constraining forces of seat belts on the basis of determination results output by the physique determination device 1.

For example, the notification control device is a device to notify that an infant is left behind, and, in a case where a physique determination result output by the physique determination device 1 is only information representing “infant,” notifies an occupant outside the vehicle that an infant is left behind in the interior of the vehicle.

The posture detecting device 4 detects the posture of an occupant in the interior of the vehicle on the basis of a captured image output by the image capturing device 2, and outputs, as a result of the detection, information about the posture (hereinbelow, described as “postural information”). For example, the posture detected by the posture detecting device 4 is the left-right orientation of the body, the up-down orientation of the face, the left-right orientation of the face, the state of the right upper arm, the state of the left upper arm or the like.

Note that the posture detected by the posture detecting device 4 is not limited to those mentioned above.

In the present first embodiment, the posture detecting device 4 detects whether or not the left-right orientation of the body is the forward-facing orientation. In addition, the posture detecting device 4 detects whether or not the left-right orientation of the face is the forward-facing orientation. In addition, the posture detecting device 4 detects whether or not the up-down orientation of the face is the horizontally-facing orientation. In addition, the posture detecting device 4 detects the state of the left upper arm. Then, the posture detecting device 4 outputs the detection results as the postural information.

It is assumed that the “forward-facing orientation” means facing the front space in the advancing direction of the vehicle. Then, it is assumed that “that the left-right orientation of the body is the forward-facing orientation” means that the rotation angle of the body in the leftward direction or in the rightward direction relative to the forward-facing orientation is smaller than a predetermined first angle.

In addition, it is assumed that “that the left-right orientation of the face is the forward-facing orientation” means that the rotation angle (yaw angle) of the face in the leftward direction or in the rightward direction relative to the forward-facing orientation is smaller than a predetermined second angle.

In addition, it is assumed that “that the up-down orientation of the face is the horizontally-facing orientation” means that the rotation angle (pitch angle) of the face in the downward direction or in the upward direction relative to the horizontally-facing orientation is smaller than a predetermined third angle.

The state of the left upper arm detected by the posture detecting device 4 is whether or not the distance of the left shoulder in the depth direction (hereinbelow, described as the “depth distance”) and the depth distance of the left elbow are close to each other, that is, whether or not the difference between the depth distance of a joint point of the left shoulder and the depth distance of a joint point of the left elbow is within a predetermined range. Here, the “depth distance” is a distance from the image capturing device 2 in the depth direction toward a subject.

Note that the posture detecting device 4 may detect the rotation angle of the body in the leftward direction or in the rightward direction relative to the forward-facing orientation, and output the detected rotation angle as the postural information. In addition, the posture detecting device 4 may detect the rotation angle of the face in the leftward direction or in the rightward direction relative to the forward-facing orientation, and output the detected rotation angle as the postural information. In addition, the posture detecting device 4 may detect the rotation angle of the face in the downward direction or in the upward direction relative to the horizontally-facing orientation, and output the detected rotation angle as the postural information.

Since it is sufficient if the posture detecting device 4 uses a well-known technology as a method of detecting the posture, an explanation thereof is omitted.

The physique determination device 1 includes a postural information acquiring unit 11, a feature identifying unit 12, a feature calculating unit 13 and a physique determining unit 14.

The postural information acquiring unit 11 acquires the postural information about the occupant output by the posture detecting device 4.

The feature identifying unit 12 identifies a feature for which the calculation condition is satisfied on the basis of the postural information about the occupant output by the posture detecting device 4 from among a plurality of features that is to be used for determination of the physique of the occupant, and each of which has a set calculation condition for calculation of the value of the feature. That is, for each feature, the feature identifying unit 12 determines whether or not the posture of the occupant satisfies the calculation condition of the feature, and identifies a feature for which the calculation condition is satisfied.

The features are the lengths between a plurality of feature points on the body, and are used for the physique determination. The feature points are predetermined points on the body of a human, and are, for example, a feature point of the nose tip, a feature point of the neck, a joint point of the right shoulder, a joint point of the left shoulder, a joint point of the right elbow, a joint point of the left elbow, a joint point of the waist, a joint point of the right wrist, a joint point of the left wrist, a joint point of the right knee, a joint point of the left knee, a joint point of the right ankle, a joint point of the left ankle and the like.

Whereas it is assumed that the plurality of features to be used for the determination of the physique are the “length of the shoulder width,” the “length of the neck” and the “length of the left upper arm” in the explanation of the present first embodiment, other features may be used.

The “length of the shoulder width” is the length between the joint point of the right shoulder or the joint point of the left shoulder and the feature point of the neck. The “length of the neck” is the length between the feature point of the nose tip and the feature point of the neck. The “length of the left upper arm” is the length between the joint point of the left shoulder and the joint point of the left elbow.

Note that the “length of the shoulder width” may be the length between the joint point of the right shoulder and the joint point of the left shoulder.

The features are associated with information representing the types of the features, and a set of a plurality of feature points is associated with each type of feature. For example, the type of the feature “shoulder width” is associated with the joint point of the left shoulder and the feature point of the neck. The type of the feature “length of neck” is associated with the feature point of the nose tip and the joint point of the neck. The feature “length of left upper arm” is associated with the joint point of the left shoulder and the joint point of the left elbow.

The calculation conditions are conditions for determining whether or not the occupant is assuming postures suited for calculation of the values of the features. Here, for each of the types of the features, a calculation condition for calculating the value of the feature is set.

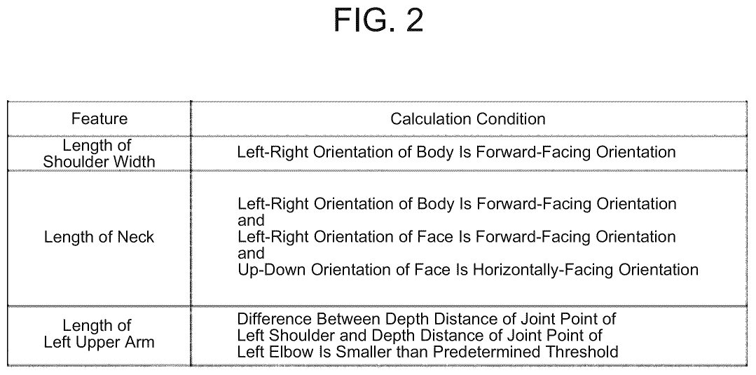

An example of a calculation condition set for each type of feature is depicted in FIG. 2.

The condition set for the type of the feature “length of shoulder width” is a condition that “the left-right orientation of the body is the forward-facing orientation.” Specifically, this is a condition that “postural information about the left-right orientation of the body is a determination result representing the forward-facing orientation.”

This is because the length of the shoulder width on a captured image becomes a value different from an actual length depending the orientation of the body, and the precision of the physique determination deteriorates.

For example, it is assumed that the length of the shoulder width on a captured image in a case where the left-right orientation of the body of the occupant is the forward-facing orientation as depicted in FIG. 3A is (a). In addition, it is assumed that the length of the shoulder width on a captured image in a case where the left-right orientation of the body of the occupant is the rightward-facing orientation relative to the forward-facing orientation as depicted in FIG. 3B is (a′). At this time, the length of the shoulder width (a′) on the captured image is detected as being shorter than an actual length, as compared to the length of the shoulder width (a) on the captured image, and accordingly the precision of the physique determination deteriorates.

Note that a first angular range for body orientation determination may be predetermined, and the calculation condition set for the type of the feature “length of shoulder width” may be that “the rotation angle of the body regarding the left-right orientation relative to the forward-facing orientation is within the predetermined first angular range.

The condition set for the type of the feature “length of neck” is a condition that “the left-right orientation of the body is the forward-facing orientation, the left-right orientation of the face is the forward-facing orientation, and the up-down orientation of the face is the horizontally-facing orientation.” Specifically, this is a condition that “postural information about the left-right orientation of the body is a determination result representing the forward-facing orientation, postural information about the left-right orientation of the face is a determination result representing the forward-facing orientation, and postural information about the up-down orientation of the face is a determination result representing the horizontally-facing orientation.”

This is because, in a case where the left-right orientation of the body becomes the leftward-facing orientation or the rightward-facing orientation relative to the forward-facing orientation, the position of the feature point of the neck changes, the length of the neck on a captured image becomes a value different from an actual length, and the precision of the physique determination deteriorates.

In addition, in a case where the left-right orientation of the face becomes the leftward-facing orientation or the rightward-facing orientation relative to the forward-facing orientation or in a case where the up-down orientation of the face becomes the upward-facing orientation or the downward-facing orientation relative to the horizontally-facing orientation, the position of the feature point of the nose tip changes, the length of the neck on a captured image becomes a value different from an actual length, and the precision of the physique determination deteriorates.

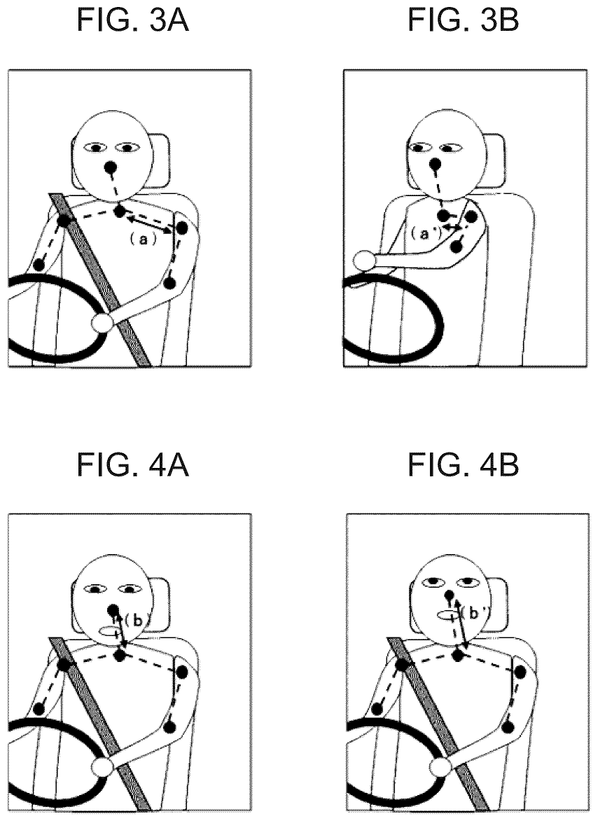

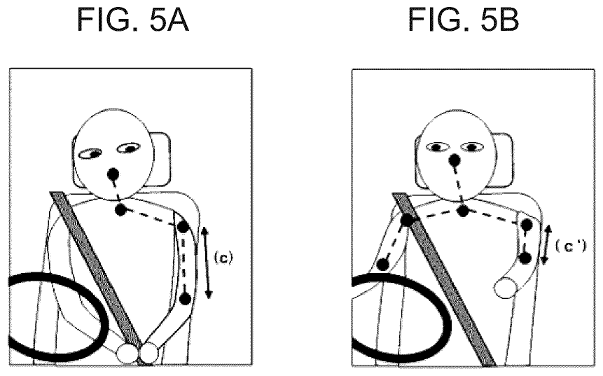

For example, it is assumed that the length of the neck on a captured image in a case where the up-down orientation of the face is the horizontally-facing orientation as depicted in FIG. 4A is (b). In addition, it is assumed that the length of the neck on a captured image in a case where the up-down orientation of the face is the upward-facing orientation relative to the horizontally-facing orientation as depicted in FIG. 4B is (b′). At this time, the length of the neck (b′) on the captured image is detected as being longer than an actual length, as compared to the length of the neck (b) on the captured image, and accordingly the precision of the physique determination deteriorates.

In addition, for example, since the feature point of the nose moves rightward in a case where the left-right orientation of the face becomes the rightward-facing orientation relative to the forward-facing orientation, the length of the neck on a captured image is detected as being longer than an actual length, and the precision of the physique determination deteriorates. In addition, for example, since the feature point of the neck moves rightward in a case where the left-right orientation of the body becomes the rightward-facing orientation relative to the forward-facing orientation, the length of the neck on a captured image is detected as being longer than an actual length, and the precision of the physique determination deteriorates.

Note that a second angular range for body orientation determination, a third angular range for face orientation determination regarding the left-right orientation and a fourth angular range for face orientation determination regarding the up-down orientation may be predetermined, and the calculation condition set for the type of the feature “length of neck” may be that “the rotation angle of the body regarding the left-right orientation relative to the forward-facing orientation is within the predetermined second angular range, the rotation angle of the face regarding the left-right orientation relative to the forward-facing orientation is within the predetermined third angular range, and the rotation angle of the face regarding the up-down orientation relative to the horizontally-facing orientation is within the predetermined fourth angular range.”

The condition set for the type of the feature “length of left upper arm” is that “the difference between the depth distance of the joint point of the left shoulder and the depth distance of the joint point of the left elbow is within the predetermined range.” Specifically, this is a condition that “postural information about the state of the left upper arm is a determination result representing that the difference between the depth distance of the joint point of the left shoulder and the depth distance of the joint point of the left elbow is within the predetermined range. This is because the length of the left upper arm on a captured image in a case where the left upper arm is extended forward becomes a value different from an actual length as compared to the case where the left upper arm is not extended forward, and the precision of the physique determination deteriorates.

For example, it is assumed that the length of the left upper arm in a case where the left upper arm is not extended forward, that is, in a case where the depth distance of the joint point of the left shoulder and the depth distance of the joint point of the left elbow are the same, as depicted in FIG. 5A is (c). In addition, it is assumed that the length of the left upper arm in a case where the left upper arm is extended forward, that is, in a case where the depth distance of the joint point of the left shoulder is greater than the depth distance of the joint point of the left elbow, as depicted in FIG. 5B is (c′). At this time, the length of the left upper arm (c′) on a captured image is detected as being shorter than an actual length, as compared to the length of the left upper arm (c) on a captured image, and accordingly the precision of the physique determination deteriorates.

The feature calculating unit 13 acquires a captured image output by the image capturing device 2. Then, the feature calculating unit 13 calculates the value of a feature identified by the feature identifying unit 12 on the basis of the captured image.

Specifically, on the basis of the captured image output by the image capturing device 2, the feature calculating unit 13 calculates the length of a line segment connecting a plurality of feature points associated with the type of the feature identified by the feature identifying unit 12. For example, in a case where the type of the feature is a type representing the “length of the shoulder width,” the feature calculating unit 13 calculates the length of a line segment connecting the joint point of the left shoulder and the feature point of the neck on the basis of the captured image.

The feature calculating unit 13 calculates feature point coordinates on the basis of the captured image. The feature point coordinates are coordinates of the feature points on the captured image. It is sufficient if a well-known technology is used as a method of calculating the feature point coordinates on the basis of the captured image. For example, it is sufficient if a machine learning model to output information representing feature point coordinates and the types of feature points by using the captured image as an input is used for calculation. The feature calculating unit 13 calculates the length of a line segment connecting a plurality of calculated feature points.

Note that the method of calculating feature point coordinates is not limited to that using a machine learning model.

The physique determining unit 14 determines the physique of the occupant on the basis of the values of features calculated by the feature calculating unit 13. Here, it is sufficient if the physique determining unit 14 uses a well-known technology as a method of determining the physique on the basis of the values of the features.

For example, the physique determining unit 14 estimates the physique by using the values of the features calculated by the feature calculating unit 13 and a learning model generated by machine learning. The learning model is generated to estimate results in response to an input by so-called supervised learning in accordance with training data generated in advance on the basis of combinations of data which are inputs and teacher labels. Here, the learning model has been trained to output information about physiques in response to the values of features in accordance with training data including the values of features as inputs and information about the physiques of occupants as teacher labels.

Next, an operation of the physique determination device 1 according to the first embodiment is explained.

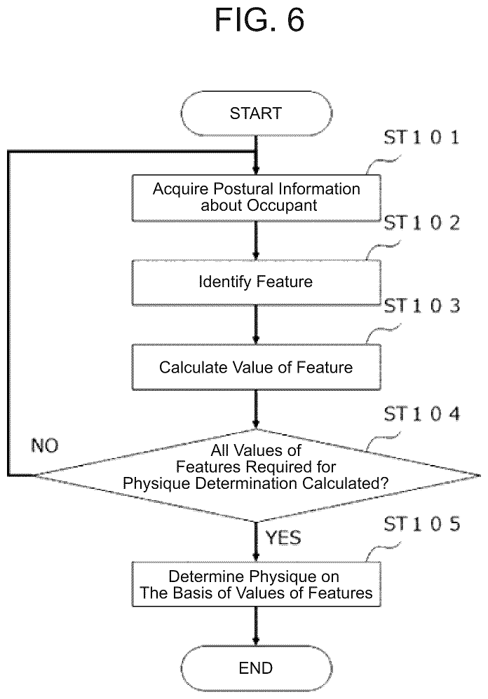

FIG. 6 is a flowchart for explaining an operation of the physique determination device 1 according to the first embodiment.

It is assumed here that an occupant whose physique is to be determined is a driver. In addition, it is assumed that features to be used for the physique determination are the “length of the shoulder width,” the “length of the neck” and the “length of the left upper arm.” Then, it is assumed that a calculation condition of the value of each feature is the calculation condition depicted in FIG. 2.

In addition, the postural information acquiring unit 11 acquires, from the posture detecting device 4 and as postural information, determination results representing “whether or not the left-right orientation of the body is the forward-facing orientation,” “whether or not the left-right orientation of the face is the forward-facing orientation,” “whether or not the up-down orientation of the face is the horizontally-facing orientation” and “whether or not the difference between the depth distance of the joint point of the left shoulder and the depth distance of the joint point of the left elbow is within the predetermined range.”

First, the postural information acquiring unit 11 acquires postural information output by the posture detecting device 4 (step ST101).

It is assumed here that, after a driver is seated on a seat, she/he is performing operation to fasten the seat belt. The posture of the driver at this time is a posture in which, as depicted in FIG. 5A, the orientation of the body is the leftward-facing orientation relative to the forward-facing orientation, the orientation of the face is the downward/leftward-facing orientation relative to the forward-facing orientation, and the position of the left shoulder in the depth direction and the position of the left elbow in the depth direction are close to each other.

The postural information acquiring unit 11 acquires a determination result representing that the left-right orientation of the body is not the forward-facing orientation, a determination result representing that the left-right orientation of the face is not the forward-facing orientation, a determination result representing that the up-down orientation of the face is not the horizontally-facing orientation, and a determination result representing that the difference between the depth distance of the joint point of the left shoulder and the depth distance of the joint point of the left elbow is within the predetermined range.

Next, the feature identifying unit 12 identifies a feature for which the calculation condition is satisfied on the basis of the information about the posture of the driver from among a plurality of features that is to be used for determination of the physique of the driver, and each of which has a set calculation condition for calculation of the value of the feature (step ST102).

On the basis of the determination results acquired by the postural information acquiring unit 11, the feature identifying unit 12 identifies the feature “length of left upper arm” as the feature for which the calculation condition is satisfied. Then, the feature identifying unit 12 outputs a type of feature representing the feature “length of left upper arm.”

The feature calculating unit 13 acquires a captured image output by the image capturing device 2, and also calculates the value of the feature identified by the feature identifying unit 12 on the basis of the captured image (step ST103).

Here, since the type of feature output by the feature identifying unit 12 is a type representing the “length of the left upper arm,” the feature calculating unit 13 calculates, on the basis of the captured image, the length between a plurality of feature points corresponding to the feature “length of left upper arm,” that is, the length between the joint point of the left shoulder and the joint point of the left elbow.

Next, the physique determination device 1 determines whether or not the values of all features required for the physique determination have been calculated (step ST104). In a case where the values of all the features required for the physique determination have been calculated (in a case of “YES” at step ST104”), the operation of the physique determination device 1 proceeds to step ST105. On the other hand, in a case where the values of all the features required for the physique determination have not been calculated (in a case of “NO” at step ST104), the operation of the physique determination device 1 returns to step ST101.

The physique determining unit 14 determines the physique of the driver on the basis of the values of the features calculated by the feature calculating unit 13, and outputs information about the physique to the control device 3 (step ST105).

Since the physique determination device 1 has not calculated the value of the feature “length of shoulder width” and the value of the feature “length of neck” here, the process of the physique determination device 1 returns to step ST101.

Next, it is assumed that after fastening the seat belt, and activating the engine, the driver started driving. Since the driver is holding the steering wheel in this case, the posture of the driver is a posture in which the position of the left shoulder in the depth direction and the position of the left elbow in the depth direction are apart from each other. In addition, the posture of the driver is a posture in which the left-right orientation of the body is the forward-facing orientation, the left-right orientation of the face is the forward-facing orientation, and the up-down orientation of the face is the horizontally-facing orientation.

Accordingly, the postural information acquiring unit 11 acquires a determination result representing that the left-right orientation of the body is the forward-facing orientation, a determination result representing that the left-right orientation of the face is the forward-facing orientation, a determination result representing that the up-down orientation of the face is the horizontally-facing orientation, and a determination result representing that the difference between the depth distance of the joint point of the left shoulder and the depth distance of the joint point of the left elbow is not within the predetermined range (step ST101).

On the basis of the determination results acquired by the postural information acquiring unit 11, the feature identifying unit 12 identifies the feature “length of shoulder width” and the feature “length of neck” as the features whose calculation conditions are satisfied. Then, the feature identifying unit 12 outputs a type of feature representing the feature “length of shoulder width” and a type of feature representing the feature “length of neck” (step ST102).

The feature calculating unit 13 acquires a captured image output by the image capturing device 2, and also calculates the value of the feature “length of shoulder width” and the value of the feature “length of neck” on the basis of the acquired captured image (step ST103).

Since the physique determination device 1 has calculated the values of all the features required for the physique determination, the operation of the physique determination device 1 proceeds to step ST105.

The physique determining unit 14 inputs the value of the “length of the shoulder width,” the value of the “length of the neck” and the value of the “length of the left upper arm” to the learning model, and determines the physique of the driver (step ST105). Then, for example, the physique determining unit 14 outputs “2: normal” to the control device 3 as a result of the determination.

Note that whereas, in the physique determination device 1, the physique determining unit 14 performs the physique determination in a case where the values of all features have been calculated, the physique determining unit 14 may perform the physique determination in a case where the values of at least two features have been calculated.

Since the precision of calculation of the values of a plurality of features to be used for the physique determination is improved by calculating the value of each of the features on the basis of a captured image captured under a condition suited for the calculation of the value of the feature in the manner above, the precision of physique determination can be improved.

Note that the posture detecting device 4 may detect whether or not the body is leaning forward and whether or not the body is leaning backward.

Then, the physique determination device 1 may use the feature “height of sitting height” for the physique determination, and a calculation condition that “the body is not leaning forward, and the body is not leaning backward” may be set for the type of the feature “height of sitting height.”

The “height of the sitting height” on a captured image is detected as being shorter than an actual length in a case where the body is leaning forward, and is detected as being longer than the actual length in a case where the body is leaning backward. Accordingly, by adding the calculation condition that “the body is not leaning forward, and the body is not leaning backward” to the type of the feature “height of sitting height,” the precision of the physique determination can be improved.

In addition, the physique determination device 1 may add a condition that “the body is not leaning forward, and the body is not leaning backward” to the calculation conditions set for the types of the features “length of shoulder width” and “length of neck.”

The “shoulder width” on a captured image is detected as being longer than an actual length in a case where the body is leaning forward, and is detected as being shorter than the actual length in a case where the body is leaning backward. In addition, the “length of the neck” on a captured image is detected as being longer than an actual length in a case where the body is leaning forward, and is detected as being shorter than the actual length in a case where the body is leaning backward. Accordingly, by adding the calculation condition that “the body is not leaning forward, and the body is not leaning backward” to the types of the features “length of shoulder width” and “length of neck,” the precision of the physique determination can be improved.

In addition, the posture detecting device 4 may detect whether or not the body is assuming the normal seated posture.

The normal seated posture is a posture in which the left-right orientation of the body is the forward-facing orientation, the left-right orientation of the face is the forward-facing orientation, and the up-down orientation of the face is the horizontally-facing orientation.

Then, the physique determination device 1 may identify features on the basis of determination results representing whether or not the body is assuming the normal seated posture.

In this case, a calculation condition that “the body is assuming the normal seated posture” is set for the type of the feature “length of shoulder width” and the type of the feature “length of neck.”

Note that whereas it is assumed regarding the physique determination device 1 mentioned above that postural information is detection results output by the posture detecting device 4, instead of or in addition to the detection results, vehicle information may be used as postural information.

For example, in a case where the physique determination device 1 sensed operation to fasten or unfasten a seat belt by an occupant on the basis of vehicle information or sensed operation on the side brake by an occupant, the physique determination device 1 determines that the posture of the occupant is a posture suited for calculation of the value of the feature “length of left upper arm.”

This is because, for example, in a case where the occupant is performing operation to fasten or unfasten the seat belt, as depicted in FIG. 5A, it is estimated that the occupant is assuming a posture in which “the difference between the depth distance of the joint point of the left shoulder and the depth distance of the joint point of the left elbow is within the predetermined range.” The same holds true in a case where the occupant operates the side brake.

In this case, the physique determination device 1 acquires vehicle information as postural information about the occupant, and, on the basis of the vehicle information, determines whether or not the posture of the occupant is a posture suited for calculation of the values of respective features.

The postural information acquiring unit 11 acquires, as the postural information, the vehicle information from an ECU which is not depicted. The vehicle information is vehicle information that allows estimation of the posture of the occupant, and, for example, is information representing operation to fasten or unfasten the seat belt, information representing operation on the side brake or the like. Specifically, it is information representing that there has been a transition from a state where the seat belt is unfastened to a state where the seat belt is fastened, information representing that there has been a transition from a state where the side brake is applied to a state where the side brake is not applied or the like.

On the basis of the vehicle information acquired by the postural information acquiring unit 11, the feature identifying unit 12 identifies a feature for which the calculation condition is satisfied.

Here, conditions using the vehicle information are set for types of feature. For example, a calculation condition that “information representing operation to fasten or unfasten the seat belt represents that there has been a transition from a state where the seat belt is unfastened to a state where the seat belt is fastened” is set for the type of the feature “length of left upper arm.” In addition, for example, a calculation condition that “information representing operation on the side brake represents that there has been a transition from a state where the side brake is applied to a state where the side brake is not applied” is set.

In addition, instead of or in addition to determination results output by the posture detecting device 4, the physique determination device 1 may use, as postural information, information output by an authenticating device that performs personal authentication of occupants.

Authentication of occupants by the authenticating device requires prior registration of personal information about the occupants on the authenticating device. The personal information about the occupants is acquired by the authenticating device on the basis of captured images of the occupants, and, for example, is the positional relationship between facial parts such as the eyes and noses.

In a case where the authenticating device sensed an occupant whose personal information has not been registered, the authenticating device causes an output device such as a display device to output information instructing the occupant to assume a posture suited for registration of personal information. Note that it is assumed that the posture suited for the registration of personal information is predetermined. Thereafter, on the basis of a captured image output by the image capturing device 2, the authenticating device determines whether or not the occupant is assuming the posture suited for the registration of the personal information, and also outputs a determination result. Then, in a case where the authenticating device determines that the occupant is assuming the posture suited for the registration of the personal information, the authenticating device acquires the personal information on the basis of the captured image.

In a case where a determination result output by the authenticating device represents that the occupant is assuming the posture suited for the registration of the personal information, the physique determination device 1 determines that the posture of the occupant is a posture suited for calculation of the value of the feature “length of shoulder width” and the value of the feature “length of neck.”

This is because the posture suited for the registration of the personal information is a posture in which the left-right orientation of the body is the forward-facing orientation, the left-right orientation of the face is the forward-facing orientation, and the up-down orientation of the face is the horizontally-facing orientation.

The postural information acquiring unit 11 acquires, as postural information, a determination result output by the authenticating device, which is not depicted, that is, a determination result representing whether or not the posture of the occupant is the posture suited for the registration of the personal information.

On the basis of the information acquired by the postural information acquiring unit 11 from the authenticating device, the feature identifying unit 12 identifies a feature for which the calculation condition is satisfied.

Here, a condition that “the information acquired from the authenticating device represents that the posture of the occupant is the posture suited for the registration of the personal information” is set for the type of the feature “length of shoulder width” or the type of the feature “length of neck.”

Note that whereas it is assumed in the explanation of the present first embodiment that a calculation condition set for each feature is the one depicted in FIG. 2, these conditions are not the sole examples, but it is sufficient if the conditions are conditions for determining whether or not the posture of an occupant matches a reference posture for the physique determination by the physique determination device 1. For example, the reference posture is a posture that has been used for generating a learning model to be used for determination of physiques by the physique determination device 1. For example, in a case where a learning model generated by using a posture in which the orientations of occupants are the rightward-facing orientations relative to the forward-facing orientations is to be used, a condition for determining whether or not the posture of an occupant is a posture in which the orientation of the occupant is the rightward-facing orientation relative to the forward-facing orientation may be used as a calculation condition.

Note that whereas the physique determination device 1 is mounted on a vehicle in the present first embodiment, it may be mounted on another mobile body.

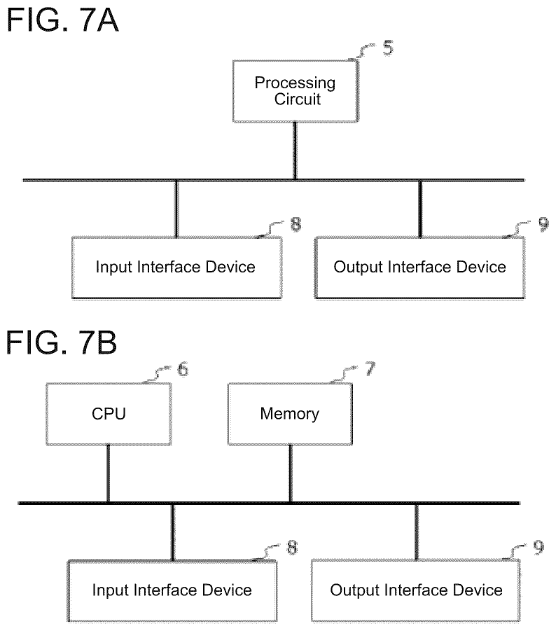

FIG. 7A and FIG. 7B are figures depicting examples of the hardware configuration of the physique determination device 1 according to the first embodiment.

In the first embodiment, the functions of the postural information acquiring unit 11, the feature identifying unit 12, the feature calculating unit 13 and the physique determining unit 14 are implemented by a processing circuit 5. That is, the physique determination device 1 includes the processing circuit 5 for performing control to calculate the value of each of a plurality of features to be used for the physique determination on the basis of a captured image captured under a condition suited for the calculation of the value of the feature, and determine the physique on the basis of the calculated values of the features.

The processing circuit 5 may be dedicated hardware as depicted in FIG. 7A or may be a central processing unit (CPU) 6 to execute programs stored on a memory 7 as depicted in FIG. 7B.

In a case where the processing circuit 5 is dedicated hardware, for example, the processing circuit 5 is a single circuit, a composite circuit, a programmed processor, a parallel-programmed processor, an application specific integrated circuit (ASIC), a field-programmable gate array (FPGA) or a combination of these.

In a case where the processing circuit 5 is the CPU 6, the functions of the postural information acquiring unit 11, the feature identifying unit 12, the feature calculating unit 13 and the physique determining unit 14 are implemented by software, firmware or a combination of software and firmware. That is, the postural information acquiring unit 11, the feature identifying unit 12, the feature calculating unit 13 and the physique determining unit 14 are implemented by the CPU 6 or a processing circuit such as a system large-scale integration (LSI) to execute programs stored on the memory 7 or the like. In addition, the programs stored on the memory 7 or the like can also be said to be ones to cause a computer to execute procedures or methods of the postural information acquiring unit 11, the feature identifying unit 12, the feature calculating unit 13 and the physique determining unit 14. Here, for example, the memory 7 is a non-volatile or volatile semiconductor memory such as a RAM, a read only memory (ROM), a flash memory, an erasable programmable read only memory (EPROM) or an electrically erasable programmable read-only memory (EEPROM) or a magnetic disk, a flexible disc, an optical disc, a compact disc, a mini disc, a digital versatile disc (DVD) or the like.

Note that the functions of the postural information acquiring unit 11, the feature identifying unit 12, the feature calculating unit 13 and the physique determining unit 14 may partially be implemented by dedicated hardware and partially be implemented by software or firmware.

In addition, the physique determination device 1 has an input interface device 8 and an output interface device 9 to communicate with the image capturing device 2, the posture detecting device 4, the control device 3 and the like.

Note that, in the present disclosure, modification of any components in the embodiment or omission of any components in the embodiment is possible.

### REFERENCE SIGNS LIST

1: Physique determination device, 2: Image capturing device, 3: Control device, 4: Posture detecting device, 5: Processing circuit, 6: CPU, 7: Memory. 8: Input interface device, 9: Output interface device, 11: Postural information acquiring unit, 12: Feature identifying unit, 13: Feature calculating unit, 14: Physique determining unit

1. A physique determination device comprising:
processing circuitry configured to
acquire information about a posture of an occupant;
identify a feature for which a calculation condition is satisfied on a basis of the information about the posture of the occupant from among a plurality of features that is to be used for determination of a physique of the occupant, the plurality of features each including a set calculation condition for calculating a value of the feature for each type;
calculate, on a basis of a captured image, the value of the feature having been identified; and
determine the physique of the occupant on a basis of the value of the feature having been calculated.

2. The physique determination device according to claim 1, wherein the information about the posture is a detection result output by a posture detecting device to detect a posture of an occupant on a basis of a captured image.

3. The physique determination device according to claim 1, wherein the information about the posture is vehicle information.

4. The physique determination device according to claim 1, wherein the information about the posture is information output by an authenticating device to perform personal authentication of an occupant.

5. The physique determination device according to claim 1, wherein the feature is a length of a shoulder width, a length of a neck or a length of an upper arm.

6. The physique determination device according to claim 5, wherein the calculation condition set for the length of the shoulder width, which is the feature, is that a left-right orientation of a body of the occupant is a forward-facing orientation.

7. The physique determination device according to claim 5, wherein the calculation condition set for the length of the neck, which is the feature, is that a left-right orientation of a body of the occupant is a forward-facing orientation, a left-right orientation of a face of the occupant is a forward-facing orientation, and an up-down orientation of the face of the occupant is a horizontally-facing orientation.

8. The physique determination device according to claim 5, wherein the calculation condition set for the length of the upper arm, which is the feature, is that a difference between a depth distance of a joint point of a shoulder of the occupant and a depth distance of a joint point of an elbow of the occupant is equal to or less than a predetermined threshold.

9. A physique determination method comprising:
acquiring information about a posture of an occupant;
identifying a feature for which a calculation condition is satisfied on a basis of the information about the posture of the occupant from among a plurality of features that is to be used for determination of a physique of the occupant, the plurality of features each including a set calculation condition for calculating a value of the feature for each type;
calculating the value of the identified feature on a basis of a captured image; and
determining the physique of the occupant on a basis of the calculated value of the feature.
